(19) United States
(12) Patent Application Publication
(10) Pub. No.: US 2009/0184645 A1
(43) Pub. Date: Jul. 23, 2009

(54) METHOD AND CIRCUIT FOR HEATING AN ELECTRODE OF A DISCHARGE LAMP

(75) Inventors: Arnold Willem Buij, Eindhoven (NL); Johan Anton Hendrikx, Oss (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/375,059

(22) PCT Filed: Jul. 12, 2007
(86) PCT No.: PCT/IB2007/052786

§ 371 Date: Jan. 26, 2009

(30) Foreign Application Priority Data
Jul. 31, 2006 (EP) 06118186.3

(51) Int. Cl. H05B 41/36

(52) U.S. Cl. 315/106; 315/307

(57) ABSTRACT

The present invention provides a method and circuit for accurately controlling heating of an electrode of a discharge lamp. According to the present invention a feedback voltage is generated. The feedback voltage is representative of an electrode voltage, in particular an electrode voltage when the discharge lamp is in a non-burning state, the electrode voltage then representing a heating voltage. The feedback voltage is compared to a predetermined reference voltage, which represents a desired heating voltage. The comparator generates and outputs an error signal representing a difference between the actual feedback voltage and the reference voltage. The error signal is supplied to a power supply circuit. The power supply circuit generates the alternating supply current corresponding to the error signal such that the electrode voltage is adjusted towards the desired heating voltage.

### FIELD OF THE INVENTION

The present invention relates to a method of controlling heating of an electrode of a discharge lamp and to a ballast circuit for operating a discharge lamp.

### BACKGROUND OF THE INVENTION

In order to limit a deterioration of an electrode of a discharge lamp, such as a fluorescent discharge lamp, the electrode is preheated prior to ignition of the discharge lamp. It is known in the prior art to control a frequency of a high frequency alternating supply current during a preheat period. The frequency of the alternating supply current may be in the order of 30-70 kHz, for example. During preheating, the frequency of the alternating supply current is relatively high, such that a voltage over the discharge lamp generated by a capacitor connected in parallel to the discharge lamp is relatively low. When the electrodes are sufficiently heated, the frequency is lowered such that the lamp voltage is increased and the discharge lamp may ignite.

In a backlighting application a discharge lamp may be operated in a pulsed manner meaning that the discharge lamp is switched on and off alternately at a predetermined pulse frequency. The pulse frequency may be in the order of 50-200 Hz. In order to control a light output of the discharge lamp, a pulse width modulation scheme may be employed, thereby controlling a duty cycle of the on- and off-periods of the discharge lamp.

During the off-periods of the discharge lamp, the electrodes may be heated. However, in order to provide a long lifetime of the discharge lamp, which is in particular important for a LCD-backlighting application, the heating should be performed very accurately. In the prior art, several methods and circuits are provided for preheating the electrodes until the discharge lamp may ignite. However, those methods and circuits are not very accurate and therefore not suitable for controlling heating of an electrode.

### OBJECT OF THE INVENTION

It is an object of the present invention to provide a method and circuit for accurately controlling heating of an electrode of a discharge lamp.

### SUMMARY OF THE INVENTION

The object is achieved in a method according to claim 1 and a ballast circuit according to claim 7.

According to the present invention a feedback voltage is generated. The feedback voltage is representative of an electrode voltage, in particular an electrode voltage when the discharge lamp is in a non-burning state, the electrode voltage then representing a heating voltage. The feedback voltage is compared to a predetermined reference voltage, which represents a desired heating voltage. The comparator generates and outputs an error signal representing a difference between the actual feedback voltage and the reference voltage. The error signal is supplied to a power supply circuit. The power supply circuit generates the alternating supply current corresponding to the error signal such that the electrode voltage is adjusted towards the desired heating voltage.

In an embodiment, the discharge lamp may be coupled to a ballast coil and the ballast coil may be a primary winding of a transformer, a secondary winding of the transformer being connected in series with a coupling capacitor and an electrode of the discharge lamp. Then, in an embodiment of the method according to the present invention, the feedback voltage may be generated based on a voltage at a node between the coupling capacitor and the secondary winding of the transformer. Thus, not the actual electrode voltage is determined and used for generating the feedback voltage. Determining of a voltage related to the electrode voltage, but not being the electrode voltage, may be advantageous, since the electrode resistance, and thereby the electrode voltage, may vary strongly, having a large tolerance of up to 20%.

In an embodiment a coupling capacitor may be connected in series to the electrode of the discharge lamp and a RC-filter may be connected in parallel to said series connection. The RC-filter may comprise a filter capacitor and a filter resistor and the RC-filter may have a RC-time constant substantially equal to the RC-time constant of a series connection of a nominal electrode resistance and the coupling capacitor. In such an embodiment, the feedback voltage may be generated at a node between the filter capacitor and the filter resistor. In particular, the filter resistor may be selected to have a large resistance compared to the electrode resistance, while the filter capacitor may have a small capacitance compared to the capacitance of the coupling capacitor in order not to substantially change the resistance and capacitance as provided by the electrode and the coupling capacitor. Thus, the addition of the filter resistor and the filter capacitor does not substantially change the operation of the circuit.

In an embodiment the power supply circuit outputs an alternating current and the step of controlling the power supply circuit comprises controlling a frequency of the alternating current. As is known in the art for preheating and igniting a discharge lamp, frequency control of the alternating supply current allows to control a lamp voltage between the lamp electrodes. Using a relatively high frequency (e.g. about 60-70 kHz), the lamp voltage is relatively low, thus only supplying a heating current to the electrodes of the discharge lamp; using a lower frequency (e.g. 30-40 kHz), the discharge lamp may be ignited and kept burning.

As mentioned above, the method according to the present invention may be advantageously employed when is operated in a pulsed operation, i.e. switching the discharge lamp alternately in on state and an off state, at a relatively low pulse frequency (e.g. 50-200 Hz).

In an aspect the present invention provides a ballast circuit for operating a discharge lamp. The ballast circuit comprises a feedback voltage circuit for generating a feedback voltage representative of an electrode voltage of an electrode of the discharge lamp; a comparator coupled to the feedback voltage circuit for comparing the feedback voltage with a reference voltage and outputting an error signal; and a power supply circuit connected to the comparator for supplying an alternating current corresponding to the error signal in order to control the electrode voltage.

### BRIEF DESCRIPTION OF THE DRAWINGS

Hereinafter the present invention and further advantageous features are described and elucidated in more detail with reference to the appended drawings illustrating non-limiting embodiments, wherein

FIG. 1 schematically illustrates a ballast circuit according to the present invention; and

FIG. 2 schematically illustrates an embodiment of a ballast circuit according to the present invention.

### DETAILED DESCRIPTION OF EXAMPLES

In the drawings, like reference numerals refer to like components.

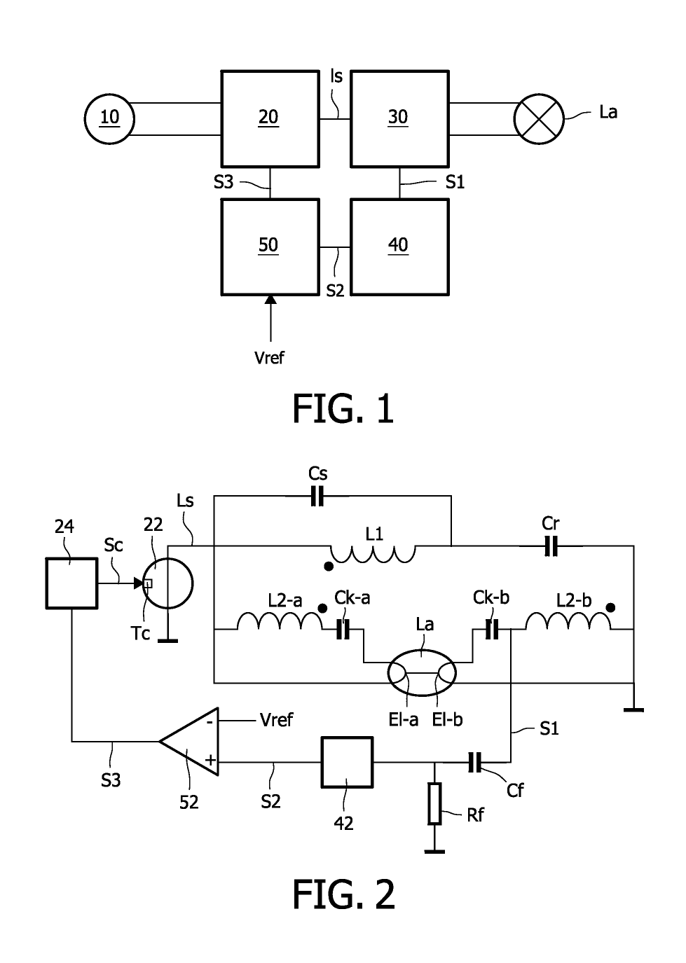

FIG. 1 illustrates a ballast circuit for operating a discharge lamp La. The ballast circuit comprises a power supply circuit 20 connected to a power supply 10, e.g. a mains power supply. The ballast circuit further comprises a driver circuit 30 for supplying a suitable driving current to the lamp La. In accordance with the present invention, the ballast circuit further comprises a feedback voltage circuit 40 and a comparator 50.

In operation, the power supply circuit 20 may receive an alternating supply voltage such as a mains voltage. The power supply circuit 20 operates on the supply voltage such that a suitable alternating supply current Is is generated. In particular, the power supply circuit may rectify the low-frequency alternating voltage and generate a high-frequency alternating supply current Is. In accordance with the prior art, the power supply circuit 20 may be configured to generate a supply current at a relatively high frequency, e.g. 60-70 kHz, for heating electrodes of the discharge lamp La prior to igniting the discharge lamp La, and lower the frequency of the supply current Is for igniting and steady-state operation of the discharge lamp La. A suitable steady-state operation frequency may be 30-40 kHz, for example.

The driver circuit 30 receives the supply current Is and is configured to provides a suitable current and a suitable voltage to the discharge lamp La. In particular, during preheating of the electrodes, as mentioned above, a relatively low voltage is applied to the discharge lamp La, thereby preventing ignition of the discharge lamp La. For ignition and during steady-state operation, a relatively large voltage is applied to the discharge lamp La. The applied voltage may be generated by a suitable capacitor, generating a low voltage in response to a high frequency signal and a high voltage in response to a low frequency signal.

In the prior art, it is known to control the frequency of the alternating supply current during preheating and ignition. The known methods and systems, however, are configured to heat the electrodes, until the electrodes reach a predetermined temperature. As soon as the electrodes have reached the predetermined temperature, the discharge lamp is ignited. In specific applications, however, the discharge lamp La is to be ignited at a predetermined point in time and in such application it is desirable to keep the electrodes at a predetermined temperature, until the discharge lamp La is to be ignited. Keeping the electrodes heated during a period of time requires an accurate control of an electrode voltage, i.e. a voltage over the electrode generated by a current flowing through the electrode due to the electrode resistance.

The feedback voltage circuit 40 generates a feedback voltage S2 from a signal S1 received from the driver circuit 30. The feedback voltage S2 corresponds to and represents the electrode voltage, which is to be controlled. The feedback voltage S2 is supplied to the comparator 50. The comparator 50 is further supplied with a reference voltage Vref. The reference voltage Vref represents a predetermined desirable electrode voltage during heating of the electrode. The comparator 50 generates an error signal S3, which corresponds to a difference between the feedback voltage S2 and the reference voltage Vref. The error signal S3 is supplied to the power supply circuit 20. In response to the error signal S3, the power supply circuit 20 changes the supply current Is such that the electrode voltage is adjusted. For example, the power supply circuit 20 may change the frequency of the supply current Is.

FIG. 2 illustrates a practical embodiment of a ballast circuit as illustrated in FIG. 1. Referring to FIG. 2, the ballast circuit comprises an inverter circuit 22. The inverter circuit generates the alternating supply current Is. The inverter circuit 22 may be a half-bridge inverter or a full-bridge inverter comprising a number of semiconductor switches, for example. The inverter circuit 22 has a control terminal Tc which is connected to a voltage controlled oscillator (VCO) driver circuit 24. In response to a control signal Sc from the VCO driver circuit 24, the inverter circuit 22 controls a frequency of the supply current Is.

In accordance with the prior art, the ballast circuit further comprises a driver circuit comprising a resonant ballast coil L1, a resonant capacitor Cr and a DC-blocking capacitor Cs, which components determine an amount of a lamp current during steady-state burning operation of the discharge lamp La. In the illustrated embodiment, the ballast coil L1 is a primary winding of a transformer. The transformer further comprises a first and a second secondary winding L2-a and L2-b, respectively. The first and the second secondary winding L2-a, L2-b are connected in series with a first and a second coupling capacitor Ck-a and Ck-b, respectively, and in series with a first and a second electrode El-a and El-b, respectively, of the discharge lamp La. The secondary windings L2-a, L2-b, the coupling capacitors Ck-a, Ck-b and the resistance of the electrodes El-a, El-b determines a heating current in a non-burning state of the discharge lamp La. A further detailed description of the normal operation of the inverter circuit and the driver circuit is omitted, since the illustrated embodiment is well known in the art and therefore a person skilled in the art readily understands how the inverter circuit, driver circuit and the discharge lamp La operate.

In accordance with the present invention, a voltage signal S1 is derived from the driver circuit. In particular, a voltage signal is derived at an output of the second secondary winding L2-b. The electrode voltage may be determined directly, e.g. by determining a peak value of the voltage signal S1, which only requires a very simple measuring circuit. However, since the electrode resistance during heating is prone to variations (a tolerance on the electrode resistance may be up to 20%) it is advantageous to connect a RC-filter to the output of a secondary winding, in the illustrated embodiment the second secondary winding L2-b. The RC-filter, comprising a filter capacitor Cf and a filter resistor Rf, has a substantially equal RC-time constant as the connection of the second coupling capacitor Ck-b and a nominal electrode resistance of the second electrode El-b.

It is noted that the transformer is selected such that it has a high transformer coupling factor. Consequently, the uncoupled inductance does not substantially influence the output voltage and it may be assumed that the output voltage of the first secondary winding L2-a and the output voltage of the second secondary winding L2-b are substantially equal.

Referring to the RC-filter comprising the filter resistor Rf and the filter capacitor Cf again, the RC-filter is connected in parallel with the electrode resistance of the electrode El-b and the coupling capacitor Ck-b. Preferably, the resistance of the parallel circuit is not substantially different from the electrode resistance, and the capacitance of the parallel circuit is not substantially different from the capacitance of the coupling capacitor Ck-b. Therefore, the resistance of the filter resistor Rf may be selected high and the filter capacitor Cf may be selected to have a relatively small capacitance. Thus, the RC-time constant may be substantially equal to the RC-time constant of the series connection of the electrode El-b (nominal resistance value) and the coupling capacitor Ck-b, while the overall resistance is not changed substantially and the overall capacitance is not changed substantially.

At a node between the filter capacitor Cf and the filter resistor Rf a filter voltage is generated that is representative of an electrode voltage of an electrode having a nominal resistance. The filter voltage is supplied to a low-pass filter circuit 42 for removing a high-frequency signal component, which is not relevant for controlling the heating of the electrode. For example, a RMS voltage value may be determined. Thus, for example, a RMS value of the filter voltage is supplied as a feedback voltage S2 to the comparator.

The comparator may comprise an operational amplifier (Op-Amp) 52. Since the relation between the heating voltage (i.e. electrode voltage) and the frequency of the supply current Is is inverted, the reference voltage Vref is applied to the negative terminal (−) of the Op-Amp 52 and the feedback voltage S2 is applied to the positive terminal (+) of the Op-Amp 52.

The error signal S3 output by the Op-Amp 52 corresponds to the difference between the reference voltage Vref and the feedback voltage S2. The error signal S3 is supplied to the VCO driver circuit 24. The VCO driver circuit 24 adjusts its output, i.e. the control signal Sc, in response to the error signal S3 such that the feedback voltage S2, and hence the electrode voltage, is adjusted. The adjustment is such that the electrode voltage, in particular the feedback voltage S2, approaches the reference voltage Vref.

The above-described control loop is in particular for use during heating of the electrodes El-a, El-b, i.e. in a non-burning phase of the lamp operation. In a burning-phase of the lamp operation, the inverter circuit 22 may be set to a predetermined frequency or may be controlled by the VCO driver circuit 24. In an embodiment, in which the inverter circuit 22 is controlled by the VCO driver circuit 24, a second error signal, i.e. not error signal S3 but another error signal, may be supplied to the VCO driver circuit 24. Such a second error signal and corresponding circuitry are not shown in FIG. 2. In a further embodiment, the electrode voltage may be controlled during a burning phase of the discharge lamp La.

Further, in another embodiment, the RC-filter comprising the filter capacitor Cf and the filter resistor Rf, the low-pass filter circuit 42 and/or the Op-Amp 52 may be replaced by a suitable signal processing circuit, such as a digital signal processing circuit.

Although a detailed embodiment of the present invention is disclosed herein, it is to be understood that the disclosed embodiment is merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the mere fact that certain measures are recited in mutually different dependent claims does not indicate that a combination of these measures cannot be used to advantage.

Further, the terms and phrases used herein are not intended to be limiting; but rather, to provide an understandable description of the invention. The terms “a” or “an”, as used herein, are defined as one or more than one. The term another, as used herein, is defined as at least a second or more. The terms including and/or having, as used herein, are defined as comprising (i.e., open language). The term coupled, as used herein, is defined as connected, although not necessarily directly, and not necessarily by means of wires.

1. A method of controlling heating of an electrode (El-a, El-b) of a discharge lamp (La), the method comprising:
generating a feedback voltage (S2) representative of an electrode voltage of the electrode of the discharge lamp;
comparing the feedback voltage with a reference voltage (Vref) for providing an error signal (S3); and
controlling a power supply circuit (20) corresponding to the error signal in order to control the electrode voltage.

2. A method according to claim 1, wherein the discharge lamp is coupled to a ballast coil (L1), the ballast coil being a primary winding of a transformer, a secondary winding (L2-a, L2-b) of the transformer being connected in series with a coupling capacitor (Ck-a, Ck-b) and an electrode of the discharge lamp, the feedback voltage being generated based on a voltage (S1) at a node between the coupling capacitor and the secondary winding of the transformer.

3. A method according to claim 1, wherein a coupling capacitor (Ck-a, Ck-b) is connected in series to the electrode of the discharge lamp and wherein a RC-filter is connected in parallel to said series connection, the RC-filter comprising a filter capacitor (Cf) and a filter resistor (Rf) and the RC-filter having a RC-time constant substantially equal to the RC-time constant of a series connection of a nominal electrode resistance and the coupling capacitor, and wherein the feedback voltage (S2) is generated at a node between the filter capacitor and the filter resistor.

4. A method according to claim 1, wherein the power supply circuit outputs an alternating supply current (Is), the step of controlling the power supply circuit comprising controlling a frequency of the alternating supply current.

5. A method according to claim 1, wherein the heating of the electrode is controlled when the discharge lamp is in a non-burning state.

6. A method according to claim 5, wherein the discharge lamp is switched alternately in a burning state and a non-burning state.

7. A ballast circuit for operating a discharge lamp (La), the ballast circuit comprising:
a feedback voltage circuit (40) for generating a feedback voltage (S2) representative of an electrode voltage of an electrode (El-a, El-b) of the discharge lamp;
a comparator (50) coupled to the feedback voltage circuit for comparing the feedback voltage with a reference voltage (Vref) and for outputting an error signal (S3); and
a power supply circuit (20) connected to the comparator for supplying an alternating supply current (Is) corresponding to the error signal in order to control the electrode voltage.

8. A ballast circuit according to claim 7, wherein the ballast circuit comprises a coupling capacitor (Ck-a, Ck-b) connectable in series with the electrode of the discharge lamp, and wherein the feedback voltage circuit comprises a filter capacitor (Cf) and a filter resistor (Rf) connectable in parallel to said series connection, wherein the feedback voltage (S2) is generated at a node between the filter capacitor and the filter resistor.

9. A ballast circuit according to claim 7, wherein the feedback voltage circuit comprises a low-pass filter circuit (42) for supplying a slowly varying voltage signal to the comparator.

10. A ballast circuit according to claim 8, wherein the low-pass filter circuit in particular being a RMS circuit for generating a RMS voltage signal.

11. A ballast circuit according to claim 7, wherein the comparator comprises an operational amplifier (52).

12. A ballast circuit according to claim 7, wherein the power supply circuit is configured to control a frequency of the alternating supply current (Is) in response to the error signal (S3).

13. A ballast circuit according to claim 11, wherein the power supply circuit comprises a voltage controlled oscillator, VCO, driver circuit (24) for controlling the frequency of the alternating supply circuit, the VCO driver circuit being coupled to the comparator (52) for receiving the error signal (S3).
